(19) United States
(12) Patent Application Publication
(10) Pub. No.: US 2009/0297780 A1
(43) Pub. Date: Dec. 3, 2009

(54) WATER-PROOF WOOD BOARD

(75) Inventor: CHIANG-SHAN SHIH, Fu Hsing Shiang (TW)

Correspondence Address: Yen Jung Sung, 21-80 38 St, #C8, Astoria, NY, 11105, US

(73) Assignee: NIA CHIOU YIU INDUSTRIAL CO., LTD., FU HSING SHIANG (TW)

(21) Appl. No.: 12/477,896

(22) Filed: Jun. 3, 2009

(51) Int. Cl. B32B 21/08; B32B 7/12; B32B 21/14

(52) U.S. Cl. 428/162; 428/514

(57) ABSTRACT

A water-proof wood board having plastic paste between a core board and surface sheets to combine the core board and the surface sheets together. The plastic paste comprises polyvinyl chloride resin, the plastic paste being placed on top surface and bottom surfaces of the core board and penetrating into the wood grain of the core board and the surface sheets. The surface sheets are placed on at least two sides of the core board with the adhesive provided by the plastic paste. The plastic paste fills in between the core board and the surface sheets and penetrates into the wood grain of the core board and the surface sheets, which completely isolates the core board the wood board. Furthermore, plastic paste provides water-proof ability and insect-proof ability for the wood board.

### BACKGROUND OF THE INVENTION

1. Field of the Invention

The present invention is related to a wood board structure, and more particularly, to a water-proof wood board, which has a plastic paste penetrating in the wood grain of both the core board and the surface sheet, in which the plastic paste combines the core board and the surface sheet together.

2. Description of the Related Art

Currently, the quality and texture of the prior art wood boards are well known and such boards are very commonly utilized in construction, furniture, and home decor. With high demand for wood boards and too many consumers requiring high quality wood board, huge amounts of forests are being deforested, which leads to the current shortage of natural resources and high price of wood boards. Consequently, manufacturers have developed plywood or particle board, which provide a cheaper wood board or numerous wood chips as a core layer and a plurality of wood sheets glued together by resin as two surface boards. The center boards are arranged alternately to increase the strength of the plywood. However, there are some common problems over extended usage periods, the reasons for which are:

The surface boards are glued together by resin, the wood board materials all have good moisture absorption abilities and there is no water-proofing capability in the entire structure. Therefore, if the plywood is utilized in a humid environment, the plywood tends to grow mold or moss or the adhesive ability is reduced. For example, Taiwan has a tropical marine climate, and plywood does not have endurance in such environments.

Since the plywood is completely composed of natural wood materials, and as resin can only provide adhesive capabilities, the plywood might suffer from vermin infestations, which causes damage.

Therefore, it is desirable to provide a water-proof wood board to mitigate and/or obviate the aforementioned problems.

### SUMMARY OF THE INVENTION

A plastic paste provides a filler between a core board and surface sheets and penetrates into the wood grain of the core board and the surface sheets, which completely isolates the core board of the wood board. The plastic paste provides water-proofing characteristics and insect-proofing capabilities for the wood board.

The plastic paste is spread on one surface of a surface sheet, as the core board is placed on the surface sheet to sandwich the plastic paste, then another layer of the plastic paste 13a is spread on the other surface of the core board 11, and a surface sheet is adhered to this side of the core board 11 with the plastic paste 13a. Therefore, both sides of the core board 11 are covered with the plastic paste, and the plastic paste respectively adheres to the surface sheets to form a plurality of interlacing layers. The core board of the wood board 10 may be composed of a plurality of wood substrates or an entire whole board, and the core board can also be designed as a plurality of combined layers with the paste disposed in between the layers and the surface sheets attached onto the most outer core board 11 surfaces. Hence, the present invention includes different structural designs for the core board 11. After the wood board 10 is assembled, pressure is applied onto both of the surface sheets to cause the plastic paste to penetrate into the wood grain of the core board and the surface sheets so the plastic paste provides a stronger adhesive effect and isolates the core board for water-proofing purposes. After the plastic paste has penetrated into the core board and the surface sheets, the wood board is heated to cure, and thus harden, the plastic paste.

Comparing With the Prior Art:

Both sides of the core board are covered with the plastic paste the surface sheets are attached onto the plastic paste form a plurality of interlacing layers, and the plastic paste layers all penetrate into the wood grain of the core board and the surface sheets. Since the plastic paste has excellent water-proofing characteristics, the wood board can have improved water resistance for improved endurance.

The plastic paste fills in between the core board and the surface sheets and penetrates into the wood grain of the core board and the surface sheets, which completely isolates the core board of the wood board; with the further heating process to reduce the presence of any living worms or parasites inside of the core board and improve the characteristic of the plastic paste, insect infestations can be prevented.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the present invention.

FIG. 2 is an exploded perspective view of the present invention.

FIG. 3 illustrates spreading plastic paste according to the present invention.

FIG. 4 illustrates compressing a water-proof wood board according to the present invention.

FIG. 5 shows penetration of the plastic paste according to the present invention.

FIG. 6 is an exploded perspective view of another embodiment of the present invention.

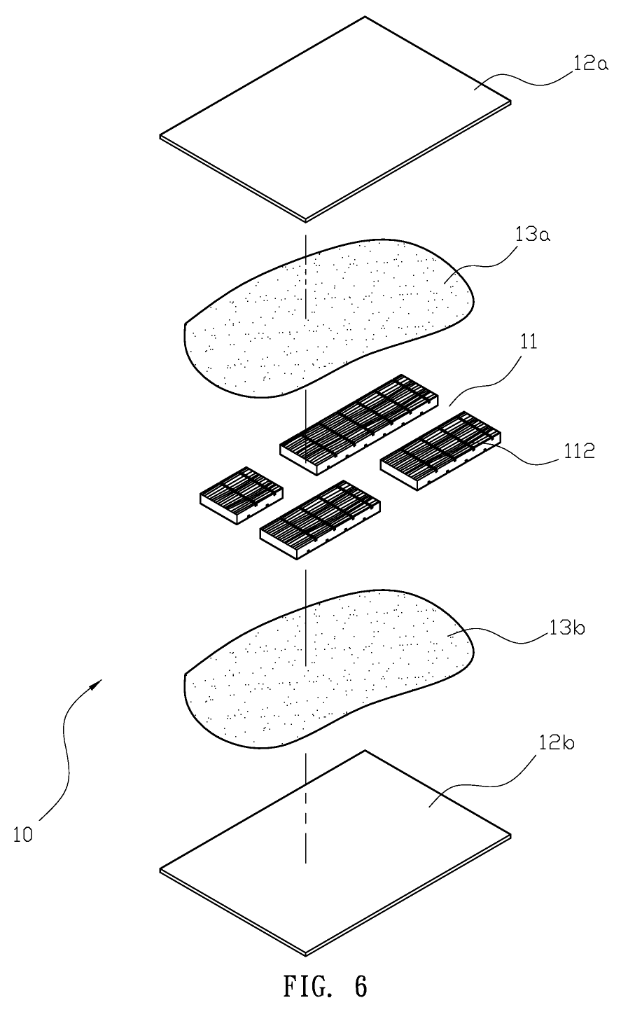

FIG. 7 is a cross-section of another embodiment of the present invention.

### DETAILED DESCRIPTION OF THE PREFERRED EMBODIMENT

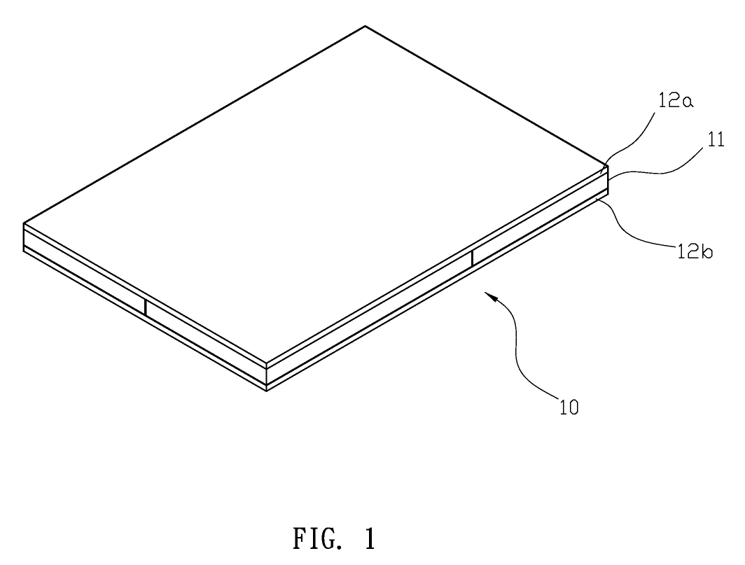

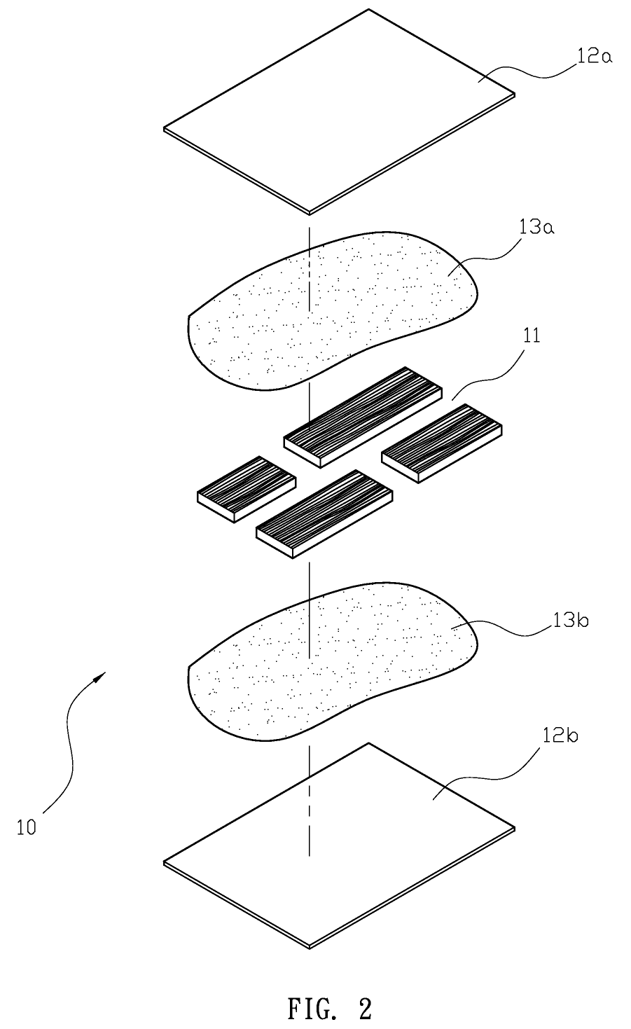

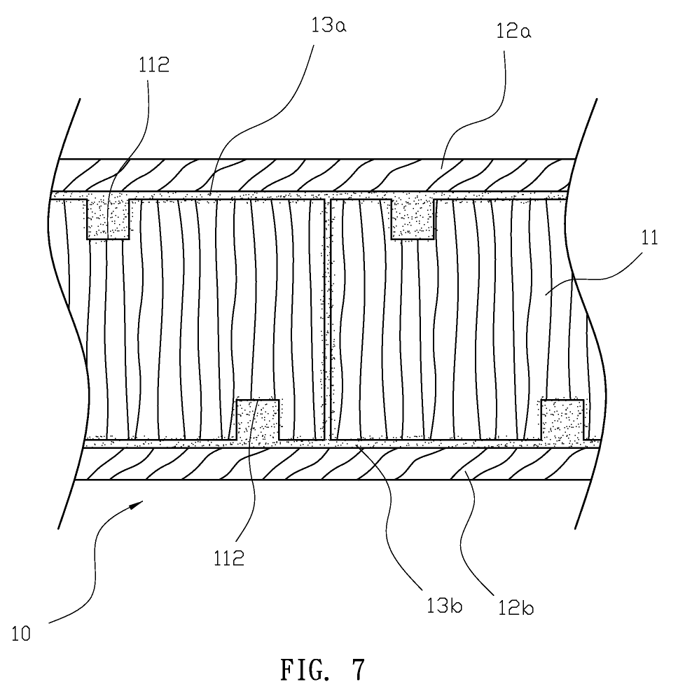

Please refer to FIG. 1 and FIG. 2. A wood board 10 comprises a core board 11, two surface sheets 12a, 12b and plastic paste 13a, 13b. The plastic paste 13a, 13b is spread between the core board 11 and the surface sheets 12a, 12b to combine and adhere them together. The core board 11 may be composed of a plurality of wood substrates or an entire whole board, and the core board 11 can be made from recycled wood board materials. The plastic paste 13a, 13b is a type of PVC plastic which is also called polyvinyl chloride resin, and the plastic paste 13a, 13b adheres to the top face and the bottom face of the core board 11 and penetrates into the wood grain 111, 121 of the core board 11 and the surface sheets 12a, 12b, as shown in FIG. 7. The surface sheets 12a, 12b are positioned to cover the two faces of the core board 11 with the adhesive provided by the plastic paste 13a, 13b.

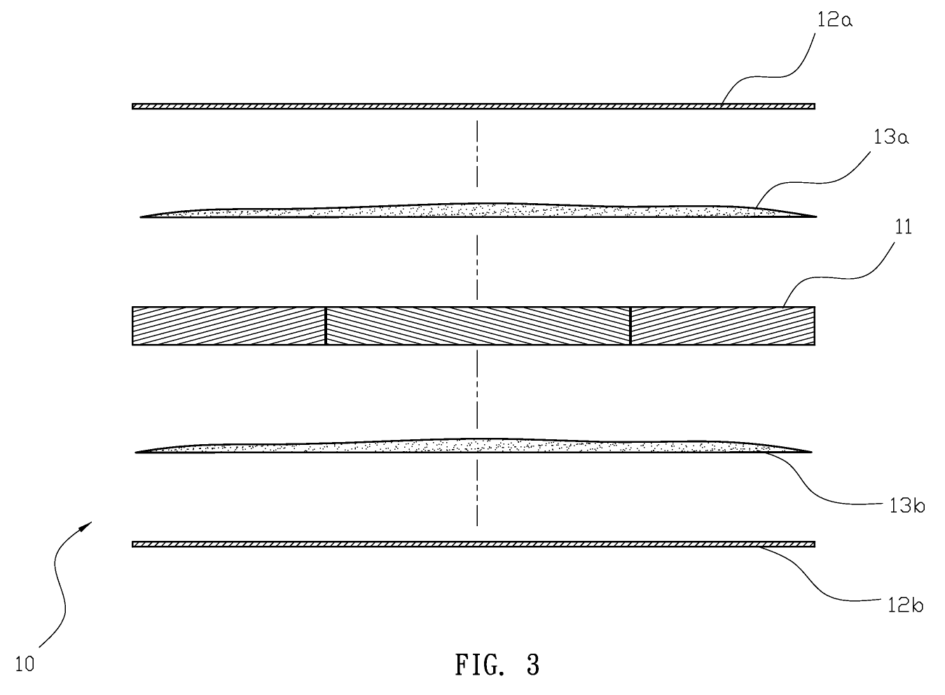

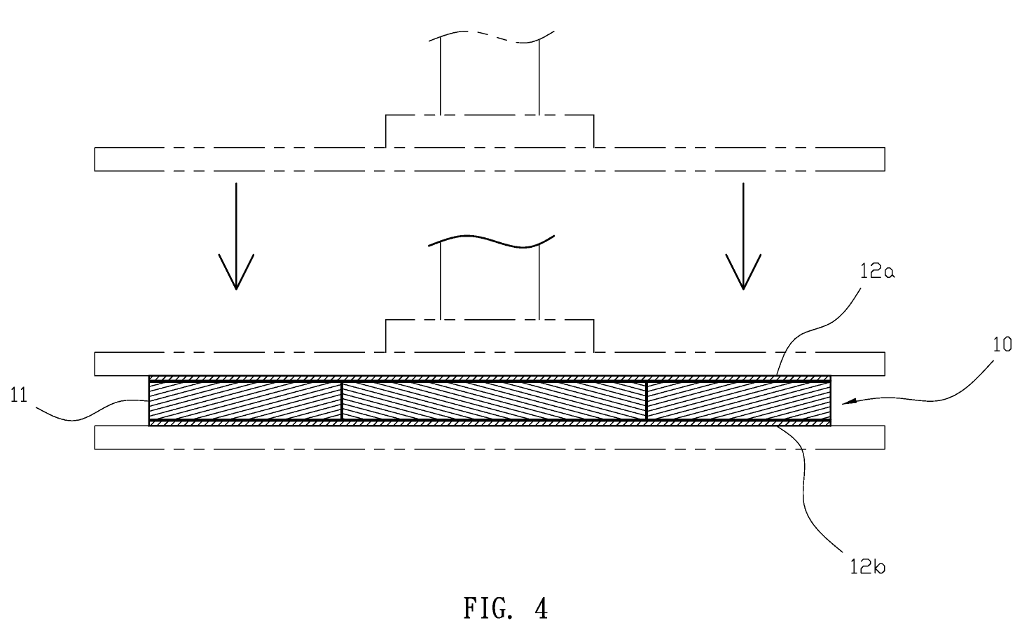

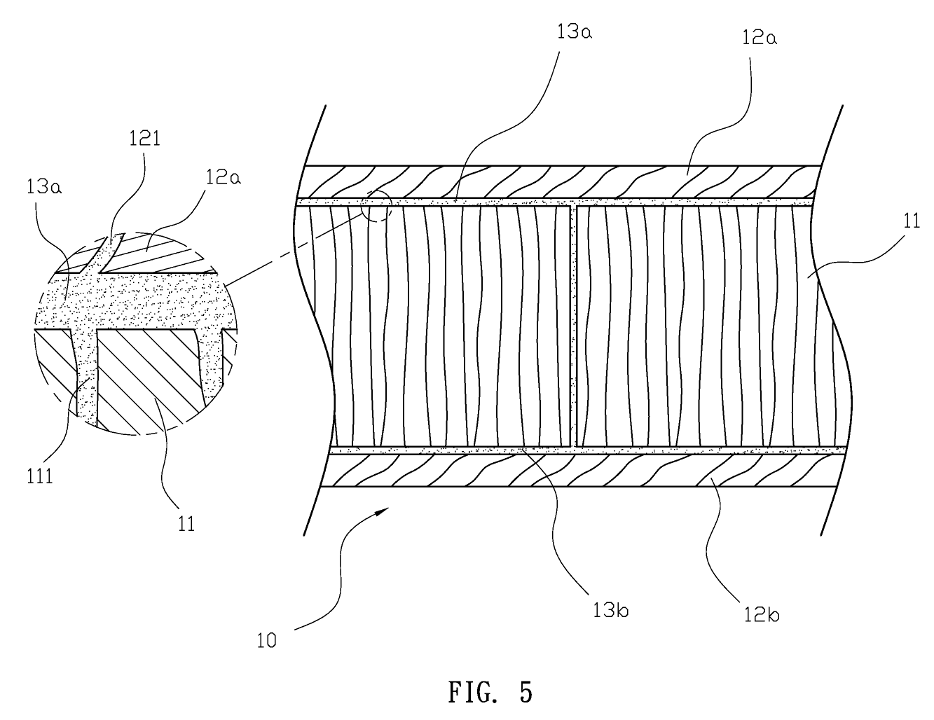

Please refer to FIG. 3, FIG. 4 and FIG. 5. The plastic paste 13b is spread on one surface of the surface sheet 12b, as the core board 11 is placed on the surface sheet 12b to sandwich the plastic paste 13b, then another layer of the plastic paste 13a is spread on to the other surface of the core board 11, and the surface sheet 12a is placed on the side of the core board 11 with the plastic paste 13a. Therefore, both sides of the core board 11 are covered with the plastic paste 13a, 13b, and the plastic paste 13a, 13b respectively adheres to the surface sheets 12a, 12b to form a plurality of interlacing layers.

The core board 11 of the wood board 10 may be composed of a plurality of wood substrates or an entire whole board, and the core board 11c can also be designed as a plurality of combined layers with the paste 13a, 13b in-between the surface sheets 12a, 12b attached onto the most outer surfaces of the core board 11. In other words, the present invention includes different structural designs of the core board 11. After the wood board 10 is assembled together, pressure is applied onto both the surface sheets 12a, 12b to cause the plastic paste 13a, 13b to penetrate into the wood grain 111, 121 of the core board 11 and the surface sheets 12a, 12b so the plastic paste 13a, 13b provides a stronger adhesive effect and isolates the core board 11 for water-proofing purposes. Moreover, after the plastic paste 13a, 13b has penetrated into the core board 11 and the surface sheets 12a, 12b, the wood board 10 is heated to cause the plastic paste 13a, 13b to harden, and a hardening agent may be added to the plastic paste 13a, 13b to increase the curing or hardening speed of the plastic paste 13a, 13b. The above-mentioned process completes the manufacturing procedure for the wood board 10.

Another embodiment of the present invention is shown in FIG. 8 and FIG. 9. The wood board 10 contains the core board 11 at the center, and the surface sheets 12a, 12b are combined with the core board 11 via the plastic paste 13a, 13b. Furthermore, a plurality of grooves 112 are formed on the top and bottom surfaces of the core board 11, and the grooves 112 are arranged in parallel. Therefore, during the assembly of the wood board 10, the plastic paste 13a, 13b also fills the grooves 112 to increase the adhesive strength between the plastic paste 13a, 13b and the core board 11, and the grooves 112 may be arranged in an alternating pattern on the top and bottom surfaces of the core board 11. The grooves 112 are preferably perpendicular to the direction of the wood grain, which can reduce the inner stress of the core board 11 to prevent bend deformation of the wood board 10 due to temperature changes.

The wood board 10 may further comprise a paper veneer, a wood veneer, or a plastic veneer on an outer surface of the surface sheets 12a, 12b, which can increase the value of the wood board 10.

With the above mentioned structure, the present invention provides the following benefits: first, both sides of the core board 11 are covered with the plastic paste 13a, 13b, the surface sheets 12a, 12b are attached onto the plastic paste 13a, 13b to form a plurality of interlacing layers, and the plastic paste layers 13a, 13b all penetrate into the wood grain 111, 121 of the core board 11 and the surface sheets 12a, 12b. Since the plastic paste 13a, 13b has excellent water-proofing characteristics, the wood board 10 can have improved water resistance for improved endurance. Second, the plastic paste 13a, 13b fills in between the core board 11 and the surface sheets 12a, 12b and penetrates into the wood grain 111, 121 of the core board 11 and the surface sheets 12a, 12b, which completely isolates the core board 11 of the wood board 10; with the further heating process to reduce the presence of any living worms or parasites inside of the core board 11 and improve the characteristic of the plastic paste 13a, 13b, insect infestations can be prevented.

Although the present invention has been explained in relation to its preferred embodiment, it is to be understood that many other possible modifications and variations can be made without departing from the spirit and scope of the invention as hereinafter claimed.

What is claimed is:

1. A water-proof wood board having plastic paste between a core board and surface sheets to combine the core board and the surface sheets together, characterized in that:
the plastic paste comprises polyvinyl chloride resin, the plastic paste being placed on top surface and bottom surfaces of the core board and penetrating into the wood grain of the core board and the surface sheets; the surface sheets being placed on at least two sides of the core board with the adhesive provided by the plastic paste.

2. The water-proof wood board as claimed in claim 1, wherein the core board is composed of a plurality of wood substrates.

3. The water-proof wood board as claimed in claim 1, wherein the core board is an entire whole board.

4. The water-proof wood board as claimed in claim 1, wherein the core board is composed of a recyclable wood board material.

5. The water-proof wood board as claimed in claim 1, wherein the plastic paste further comprises a hardening agent to increase the hardening speed of the plastic paste.

6. The water-proof wood board as claimed in claim 1, wherein the core board comprises a plurality of parallel grooves on the at least two surfaces, the plastic paste filling the grooves.

7. The water-proof wood board as claimed in claim 6, wherein the grooves are alternately disposed on the two surfaces of the core board, the grooves substantially perpendicular to the direction of the wood grain of the core board.

8. The water-proof wood board as claimed in claim 1, wherein the wood board further comprises a paper veneer, wood veneer, or plastic veneer on an outer surface of the surface sheet.
